(19) United States
(12) Patent Application Publication
(10) Pub. No.: US 2025/0158947 A1
(43) Pub. Date: May 15, 2025

(54) METHODS AND SYSTEMS FOR INTELLIGENT MESSAGE PLATFORMS

(71) Applicant: META PLATFORMS, INC., Menlo Park, CA (US)

(72) Inventors: Vincent Charles Cheung, Menlo Park, CA (US); Hadi Michel Salem, New York, NY (US); Kaolin Imago Fire, Berkeley, CA (US); Catherine Suzanne Trono, San Francisco, CA (US); Yipin Zhou, Cambridge, MA (US); Marc David, San Francisco, CA (US); Aran Mun, Seattle, WA (US); Gaurav Pankaj Sharma, San Francisco, CA (US)

(21) Appl. No.: 18/946,365

(22) Filed: Nov. 13, 2024

Related U.S. Application Data
(60) Provisional application No. 63/598,875, filed on Nov. 14, 2023.

(51) Int. Cl. H04L 51/10; G06T 5/50; G06T 13/40; H04L 51/04

(52) U.S. Cl. CPC H04L 51/10; G06T 5/50; G06T 13/40; H04L 51/04; G06T 2207/20221

(57) ABSTRACT

Methods and systems are described for an intelligent messaging platform between users to foster more an immersive and creative messaging environment. In various examples, systems and methods may receive, via a device associated with a user, a media input. Context associated with the media input may be determined. The creation of a media item may be based on the media input and context associated with the media input. The creation of a media item may be based on the use of a machine learning model. The media may be provided to a user or group of users via one or more user devices associated with the users.

### CROSS-REFERENCE TO RELATED APPLICATION

This application claims the benefit of U.S. Provisional Patent Application No. 63/598,875, filed on Nov. 14, 2023, entitled “Methods And Systems For Intelligent Message Platforms,” the contents of which are hereby incorporated by reference herein.

### TECHNOLOGICAL FIELD

Examples of the present disclosure relate generally to methods, apparatuses, and computer program products for an intelligent media generation system.

### BACKGROUND

Many users may attempt to express themselves via various methods, such as but not limiting to, capturing images, recording videos, or recording audio, and sharing those captured forms of media. However, there may be limitations to the self-expression of users depending on what may be captured in an environment associated with the user or what forms of media may be found on the Internet.

In view of the foregoing drawbacks, it may be beneficial to provide a method of intelligent media generation for improving flexibility and adaptability of electronic devices to capture or produce desired self-expression of users.

### BRIEF SUMMARY

Methods and systems are described for utilizing artificial intelligence (AI) to generate media associated with an electronic device based on an input.

A method, system, computer program product, or apparatus may provide for receiving a first media input in a messaging thread, wherein the messaging thread comprises participants associated with multiple user profiles, wherein the multiple user profiles comprise a first user profile and a second user profile, wherein the first media input is associated with a change of a first portion of a first media output, wherein the first media input is associated with the first user profile; receiving a second media input in the messaging thread, the second media input associated with a change of a second portion of the first media output, the second media input associated with the second user profile; determining context associated with the first media input and the second media input using a machine learning model; and generating a second media output based on the context. The second media output may include an animation associated with the first media output. This method may allow for collaborative media creation and modification within a messaging environment, leveraging machine learning to understand context and generate animated outputs based on multiple users' inputs.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates an example system for intelligent messaging in accordance with the present disclosure.

FIG. 2 illustrates a method of intelligent messaging in accordance with an example of the present disclosure.

FIG. 3A illustrates intelligent messaging in accordance with an example of the present disclosure.

FIG. 3B illustrates intelligent messaging in accordance with an example of the present disclosure.

FIG. 4A illustrates intelligent messaging in accordance with an example of the present disclosure.

FIG. 4B illustrates intelligent messaging in accordance with an example of the present disclosure.

FIG. 5 illustrates intelligent messaging emoji examples in accordance with the present disclosure.

FIG. 6 illustrates intelligent messaging in accordance with an example of the present disclosure.

FIG. 7 illustrates intelligent messaging in accordance with an example of the present disclosure.

FIG. 8 illustrates a method for intelligent messaging in accordance with an example of the present disclosure.

FIG. 9 illustrates an example block diagram of an electronic device in accordance with an example of the present disclosure.

FIG. 10 illustrates an example processing system in accordance with an example of the present disclosure.

FIG. 11 illustrates a machine learning model and training data in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being transmitted, received and/or stored in accordance with embodiments of the disclosure. Moreover, the term “exemplary”, as used herein, is not provided to convey any qualitative assessment, but instead merely to convey an illustration of an example. Thus, use of any such terms should not be taken to limit the spirit and scope of embodiments of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, “artificial reality” may refer to a form of immersive reality that has been adjusted in some manner before presentation to a user, which may include, for example, a virtual reality, an augmented reality, a mixed reality, a hybrid reality, Metaverse reality or some combination or derivative thereof. Artificial reality content may include completely computer-generated content or computer-generated content combined with captured (e.g., real-world) content. In some instances, artificial reality may be associated with applications, products, accessories, services, or some combination thereof, that may be used to, for example, create content in an artificial reality or are otherwise used in (e.g., to perform activities in) an artificial reality.

As referred to herein, “artificial reality content” may refer to content such as video, audio, haptic feedback, or some combination thereof, any of which may be presented in a single channel or in multiple channels (such as stereo video that produces a three-dimensional (3D) effect to the viewer) to a user.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, “media” may refer to content items that may be captured, shared, posted or the like between users and/or via a platform (e.g., a social media platform, a messaging platform, or the like). As examples the media may include, but is not limited to, audio, text, images, videos, and/or the like.

It is to be understood that the methods and systems described herein are not limited to specific methods, specific components, or to particular implementations. It is also to be understood that the terminology used herein is for the purpose of describing particular embodiments only and is not intended to be limiting.

Messaging platforms have become ubiquitous for communication between users. Many messaging platforms allow users to share media such as images, videos, and audio. However, existing platforms typically provide limited options for users to creatively modify or generate new media within the messaging interface itself. In some conventional systems, visual self-expression in messaging or online platforms may be limited to predefined media, such as static images, videos, audio, or the like. Users often have to use separate applications to edit media before sharing it in a message. Artificial intelligence capabilities present opportunities for creative expression that may not be fully leveraged in messaging contexts. Existing AI-based media generation tools are often standalone applications disconnected from messaging workflows. There is a need for messaging platforms, such as for example social media platforms, that seamlessly integrate powerful AI-based media modification and generation capabilities to enhance creative expression and engagement between users.

The present disclosure is generally directed to systems and methods for an intelligent messaging platform in which artificial intelligence may be utilized to adjust/modify, or create/generate media (e.g., images, videos, audio, or the like). Examples of the present disclosure may include the use artificial intelligence to perform adjustment to or generation of media. Examples of the AI adjustment or generation associated with media may include adding or removing content items or areas of interest, replacing areas or content items of interest, changing the background associated with the media, adjusting/modifying the style associated with the media, building on ideas between users to the media, changing the format of the media, or changing the composition of the media.

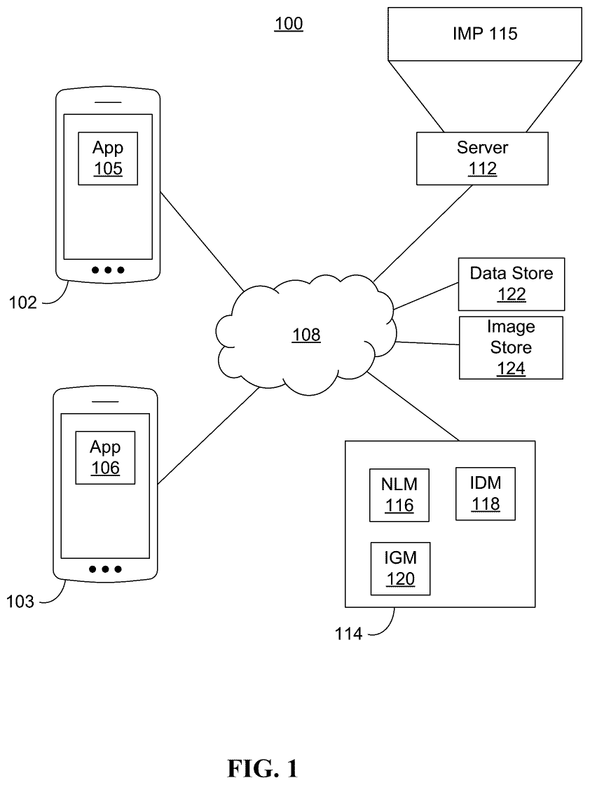

FIG. 1 illustrates an example system 100 for implementing the disclosed subject matter. System 100 may include user device 102, user device 103, server 112, artificial intelligence (AI) processing system 114, data store 122, or image model store 124 connected via a network 108. The messaging server 112 may connect with AI processing system 114, in which AI processing system 114 may incorporate a natural language processing module 116, an intent detection module 118, or an image generation module 120. The AI processing system 114 accesses a training data store 122 and an image model store 124. User device 102 may be a smartphone, tablet, laptop computer, or other device, which may allow for text, voice, or other communication. It is contemplated that components herein may be physical or functional components.

User device 102 may include messaging application 105. When media is captured using this application 105. In an example, messaging application 105 may be a standalone app or integrated into a social media platform app. The messaging application 105 or messaging application 106 may provide user interfaces for text-based communication or media content display. Messaging application 105 may be associated with a first user profile and messaging application 106 may be associated with a second user profile. It is contemplated that the capabilities or components of user device 103 and messaging application 106 may be similar to or the same as user device 102 and messaging application 105, respectively.

Messaging server 112 may manage the functionality of the messaging service, including message routing, user authentication, or conversation persistence. Messaging server 112 also may serve as the interface between the messaging clients and the AI processing system 114. Messaging server 112 may include an intelligent messaging platform (IMP) 115. IMP 115 may be a network-addressable computing system that can host an online messing network. IMP 115 may generate, store, receive, or send information associated with a user, such as, for example, user-profile data or other suitable data related to the IMP 115. IMP 115 may be accessed by one or more components of system 100. As an example, user device 102 may access IMP 115 located on server 112 by using a web browser or a native application on user device 102 associated with IMP 115 (e.g., a messaging application, a social media application, another suitable application, or any combination thereof).

AI processing system 114 may include some components that enable the contextual image generation and manipulation features. The natural language processing module (NLM) 116 may analyze incoming text messages to understand their semantic content and context. Intent detection module (IDM) 118 may use this analysis to determine when input associated with a user profile (e.g., text, image, or gestures) express an intent (explicitly or implicitly) to generate or manipulate images. Image generation module (IGM) 120 may create, modify, or animate images based on the detected intents, which may be associated with textual descriptions.

Training data store 122 may include datasets used to train the various AI models employed by system 100. This may include conversational data, image-text paired data, or labeled intent data, among other things. The image model store 124 may include the trained image generation or manipulation models used by the system.

To improve performance or user experience, system 100 may incorporate one or more optimization techniques as further disclosed herein. A first technique may include using progressive image loading, in which generated images are initially transmitted as low-resolution previews and refined as higher-quality versions are processed. This may provide rapid initial display, reducing wait times while the full-quality image is rendered in the background. Another technique may include predictive pre-generation, where the system analyzes ongoing conversations to anticipate potential image generation requests. By pre-generating likely image candidates in the background, perceived response time is reduced when users request specific visuals.

The system may use adaptive model selection technique, dynamically choosing appropriate image generation models based on factors including conversation context, user preferences, or current system load. This may allow for efficient resource management while ensuring relevant output. A distributed caching technique may improve performance by storing frequently used image elements and generation results across system 100, allowing for quick retrieval in cases of similar or repeated requests.

For the user interface of messaging application 105, there may be suggestion bubbles that appear within the conversation interface when an opportunity for image generation arises. These suggestion bubbles may allow users to trigger the creation of visuals without interrupting their typing or conversational flow. Generated images may be displayed within an interactive canvas, enabling direct manipulation through gestures such as pinch-to-zoom or swipe-to-pan. Modifications may be requested or suggested through these gestures.

System 100 may keep a visual history in data store 122, preserving generated and modified images so users may revert to earlier versions or explore alternative branches of image development. In group conversations of a group chat session, the interface may support collaborative image refinement by offering mechanisms for multiple participants to contribute, including voting systems and layer-based editing options. Personal style presets may be defined and stored for a user profile, which may be applied to generated images to quickly implement preferred visual aesthetics. These features may create a flexible and user-centric system that may assist with technical performance and creative potential of the image generation process.

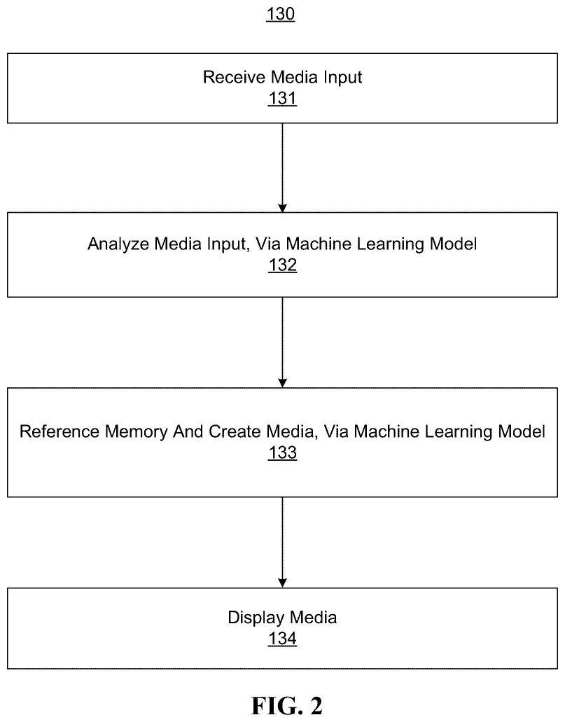

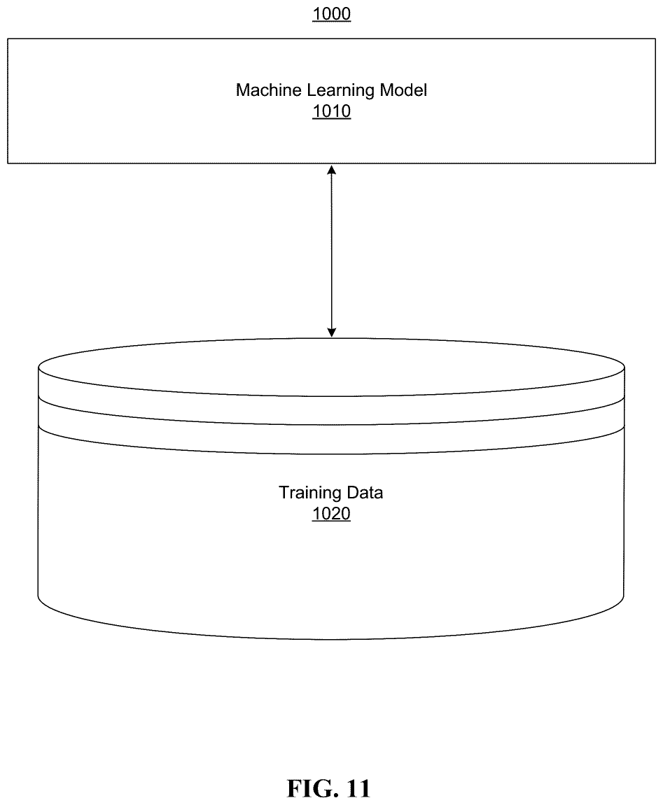

FIG. 2 illustrates a method of intelligent messaging in accordance with an example of the present disclosure. The method 130 may be performed by a device (e.g., user device 102, computing system 800). The device may utilize one or more of processors (e.g., processors 32, processor 91), memories (e.g., non-removable memory 44, removable memory 46, ROM 93, RAM 82), or a memory controller (e.g., memory controller 92) in part to perform the method 130. At step 131, a media input may be received. In some examples, the received media input may be a prompt to initiate the use of an intelligent messaging platform 115. The received prompt may be a particular string of text such as “@ AI/create” (e.g., @ AI/generate) to initiate the intelligent messaging platform 115. At step 132, the media input may be analyzed via a machine learning model (e.g., machine learning model 1010 of FIG. 11). The machine learning model 1010 may facilitate implementing the intelligent messaging platform 115 which may generate (e.g., modify or create) content to display on a user interface (UI) of a user device 102 (also referred herein as media output). At step 132, the media input may be analyzed for context to determine intent. For example, media input, such as @ AI/create image a bike, may be received, in which the “image a bike” may be the media input. The intelligent messaging platform 115 may determine an intention (e.g., an indication) to display an image of a bike. In some examples, the intelligent messaging platform 115 may present the image of the bike via application 105. In some examples, the media input may be analyzed in conjunction with or in addition to a conversation between one or more users and/or a plurality of media associated with a conversation associated with one or more user profiles (e.g., a group chat or the like).

At step 133, the media output may be generated based on the analysis of the media input of step 132. In some examples, the intelligent messaging platform 115 (e.g., a messaging platform, social media platform, or the like) may have a list of media that may be used. For example, the intelligent messaging platform 115 may provide a list of bike images in which one or more of the bike images may be selected. As disclosed in more detail herein, the media output may be determined, via a machine learning model 1010, based on an assessment of the context of the media input, a conversation associated with a user profile, a historical database, or one or more attributes associated with the user (e.g., a user profile detailing user activity or preferences). The historical database may include books, newspapers, articles, conversations, television shows, or the like. At step 134, the media output may be displayed via user device 102. In some examples, the media output be a displayed via application 105 or application 106, which may be a group of users in a messaging thread (e.g., in a group chat) . . . . It is contemplated that the steps of FIG. 2 may occur iteratively, sequentially, or approximately simultaneously.

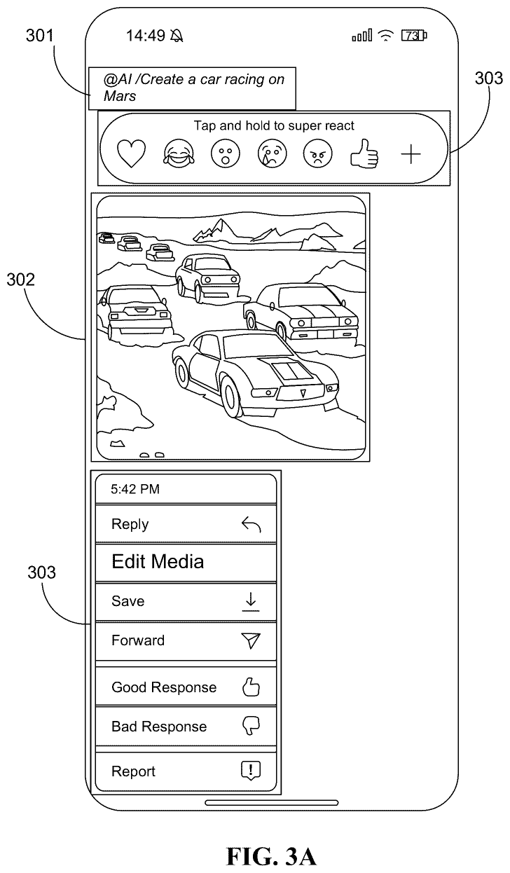

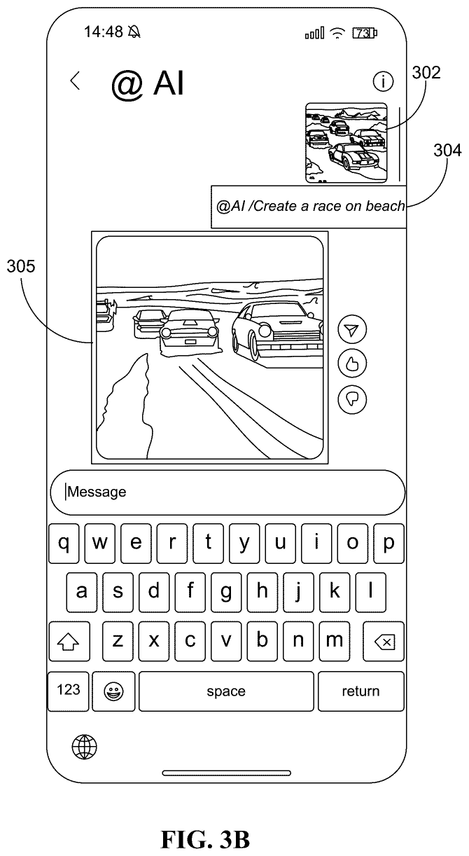

FIG. 3A and FIG. 3B illustrate an example use of system 100, in which there may be an interaction with a generated AI mechanism (e.g., an AI chatbot or bot). In FIG. 3A, a first media input 301 (e.g., @ AI/create a car racing on Mars) which may result in system 100 providing a first media output 302, which may be associated with cars racing on Mars. Menu 303 may be shown on application 105 of user device 102 with regard to first media output 302 (e.g., after a predetermine time increment threshold or a pressure threshold).

The edit image button associated with the menu 303 of FIG. 3A is shown, and a second media input 304 of FIG. 3B may be provided as shown. The second media input 304 may indicate the text “ . . . on beach.” The machine learning model may determine a car race on the beach due to the context of the second media input 304 in association with first media output 302, in which second media output 305 may be created. As further disclosed herein the first media output 302 and the second media output 305 may be combined based on context.

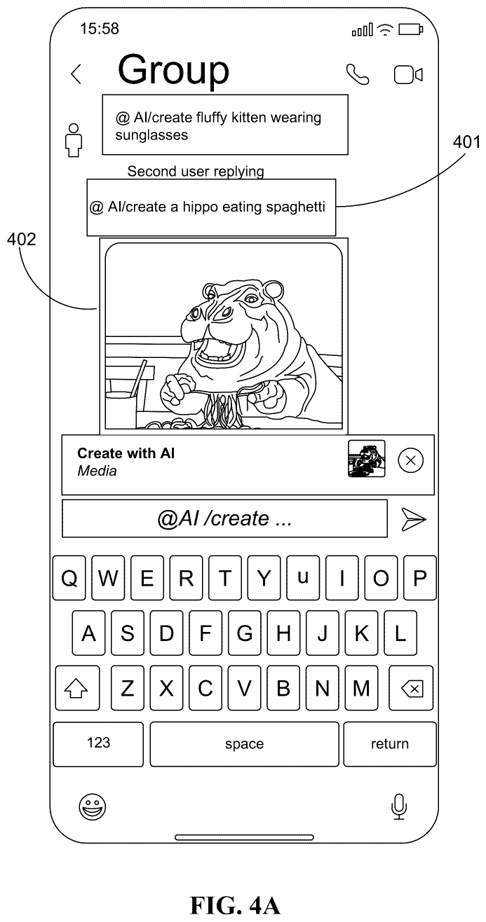

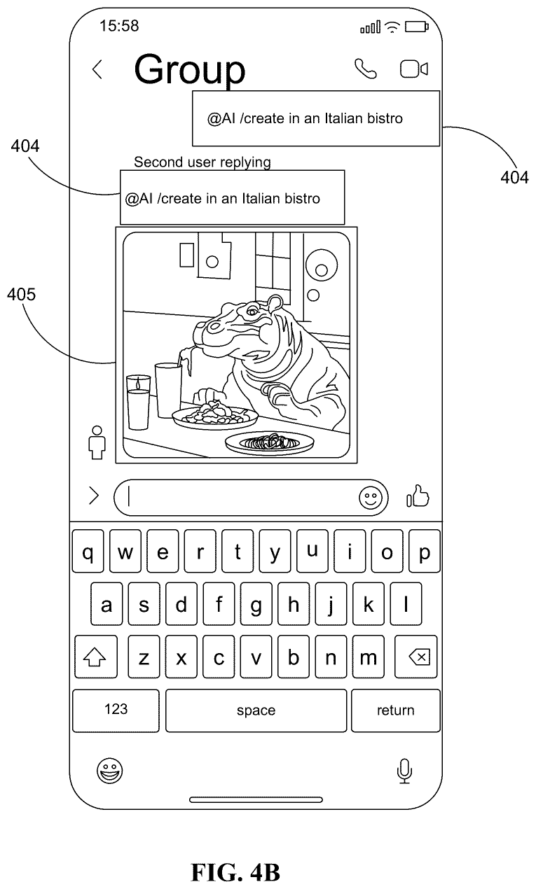

FIG. 4A and FIG. 4B illustrate an example use of system 100, in which there may be an interaction with a generated AI mechanism (e.g., an AI chatbot or bot). In FIG. 4A, a first media input 401 (e.g., @ AI/create a hippo eating spaghetti) which may result in system 100 providing a first media output 302, which may be associated with hippo eating as referenced.

A second media input 404 of FIG. 4B may be provided as shown. The second media input 404 may indicate the text “ . . . in an Italian Bistro.” The machine learning model may determine a different scene with the hippo due to the context of the second media input 404 in association with first media output 402, in which second media output 405 may be created. As further disclosed herein the first media output 402 and the second media output 405 may be combined based on context.

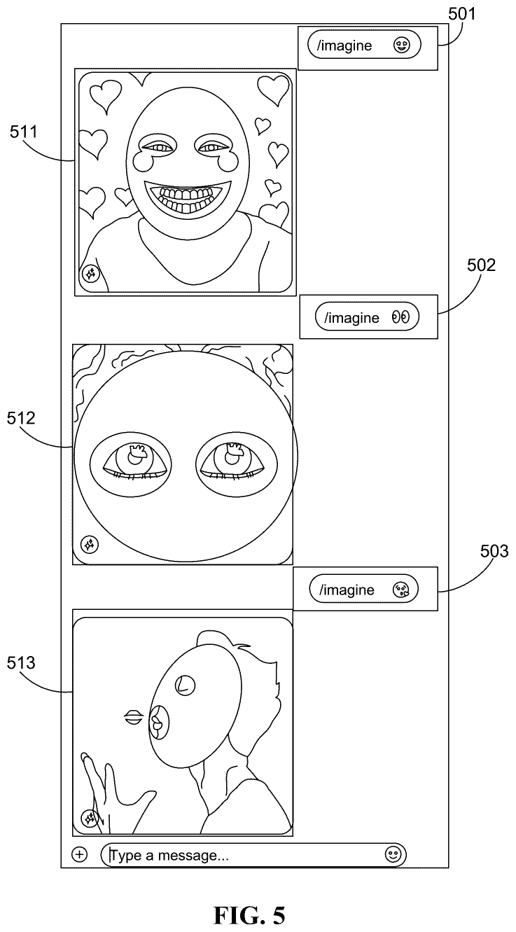

FIG. 5 illustrates an example modification associated with emojis in accordance with the present disclosure. As shown in FIG. 5, a media input may be an emoji (e.g., media input 501, media input 502, media input 503), in which the machine learning model 1010 may generate the media associated with the media input. The media input 501 may be associated with media output 511, in which the media input 501 may include an emoji illustrating a smiling face with heart eyes where the machine learning model may create a user with the same effect in media output 511. As disclosed further herein, one or more images or other media associated with a user profile may serve as the basis of generating (e.g., modifying) media output 511. Media input 502 may be associated with media 512, in which the media input 502 may include an emoji focusing on eyes where the machine learning model 1010 may generate an image of user associated with a user profile with the same focus in media 512. Media input 503 may be associated with media 513, in which media input 503 may include an emoji illustrating a smiling face with lips in a puckered fashion where the machine learning model 1010 may generate a media 513 in which an image of user associated with a user profile may be shown with a smiling face and in a position where the users' lips may be puckered.

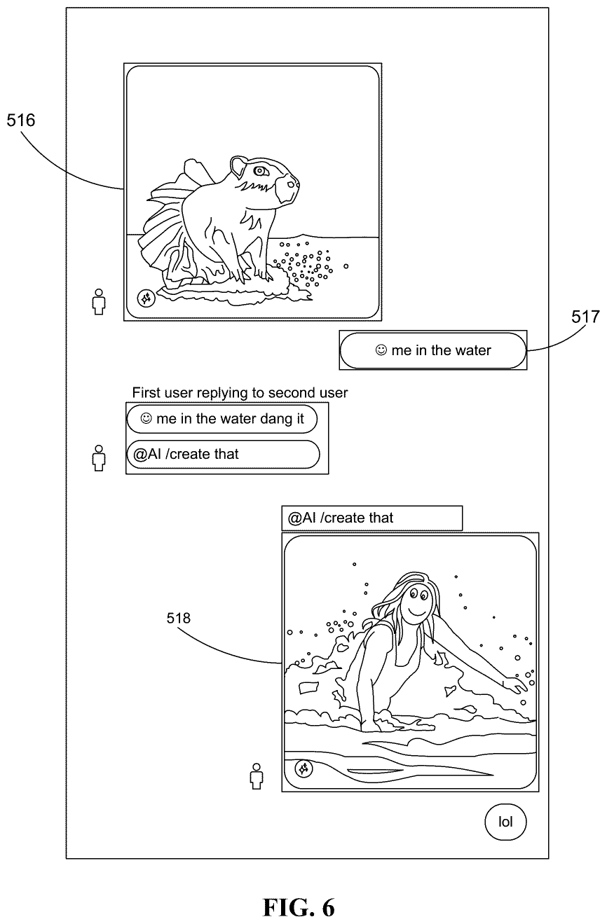

FIG. 6 illustrates an example media modification. As shown, there may be media input 516 which is a squirrel wading through the water. This media input 516 may be created based on generative AI or by other means. The media input 516 may be submitted into the chat by a first user. Media input 517 may be submitted by a second user. The machine learning model 1010 may utilize the media input 517 and media input 516 to generate media output 518. Media output 518 may be a profile picture with an emoji type face that is similar to media input 516 (based on context). It is contemplated that such use of the machine learning model 1010 may be an option that may be actively on to react to media input generally or specifically prompted.

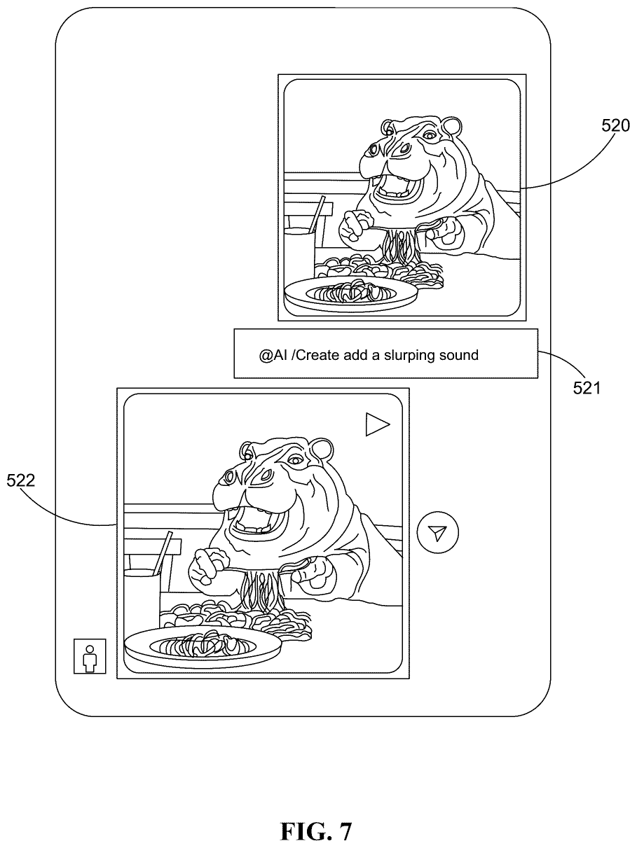

FIG. 7 illustrates example media output generated in response to a media input. In the example of FIG. 7, media input may include media input 520 (image of hippo) and media input 521 (e.g., @ AI/create) as shown. Media input 521 may indicate to “add slurping sound,” wherein the term “sound” may indicate to the machine learning model to create a sound associated with the media input 520. The sound (e.g., slurping) may be played with generated media 522. Another option as further disclosed herein, would be transform the hippo to an image linked with a profile (which may be a person, another animal, robot, or the like) and also incorporate the previous slurping sound.

It is contemplated that various terms utilized in a media input may indicate a want or desire, implemented via the machine learning model, associated with a user to receive a particular type of media (e.g., audio, video, image, text, or the like). As illustrated in Table 1, examples of media inputs and potential combinations of media outputs associated with the context of the media input are provided.

TABLE 1

| | | Output | | | | |
|---|---|---|---|---|---|---|
| | | Text | Image | Video | Audio | Video + Audio |
| Input | Text | Text to | Text to | Text to | Text to | Text to Video + |
| | | Text | Image | Video | Audio | Audio |
| | Image | Image to | Image to | Image to | Image to | Image to Video + |
| | | Text | Image | Video | Audio | Audio |
| | Video | Video to | Video to | Video to | Video to | — |
| | | Text | Image | Video | Audio | |
| | Audio | Audio to | Audio to | Audio to | Audio to | Audio to Video + |
| | | Text | Image | Video | Audio | Audio |

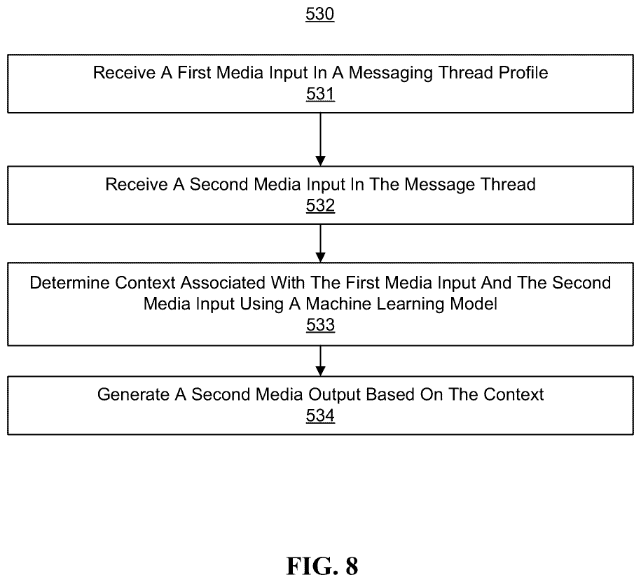

FIG. 8 illustrates an example method 530 for collaborative media generation in a messaging environment as disclosed herein. At step 531, a first media input is received in a messaging thread. The messaging thread may include participants associated with multiple user profiles, including a first user profile and a second user profile. The first media input may be for generating a change of a first portion of a first media output (e.g., media input 516 and may be associated with the first user profile.

At step 532, a second media input (e.g., media input 517) is received in the message thread. This second media input may be for generating a change of a second portion of the first media output and is associated with the second user profile. This step demonstrates the collaborative nature of the method, where multiple users may contribute to modifying a shared media output.

At step 533, context associated with both the first media input and the second media input may be determined using a machine learning model. This context determination may be used for understanding the intentions and desired outcomes of the participants in the messaging thread. The use of a machine learning model used herein may consider factors such as the content of the media inputs, the history of interactions in the messaging thread, or broader contextual information about the users and their relationships.

At step 534, based on the determined context, a second media output (e.g., media output 518) may be generated. This second media output may take various forms, such as an animation associated with the first media output. The flexibility of the output format may allow for diverse and engaging collaborative creations.

The method accommodates various types of media inputs and modifications. For instance, the change of the first portion of the first media output might involve adding audio to the first media output. Additionally, the first media input may include text, showcasing the ability to process and integrate different forms of user input.

The method may include provisions for privacy and consent in collaborative media creation. A determination may be made regarding whether there is an indication of permission to combine an image associated with the first user profile with the first media output. This may help ensure that user privacy is respected in the collaborative process. Privacy considerations herein may be addressed by requiring permission checking before combining user-associated images. This approach may be extended to other types of personal data or content, ensuring that collaborative creativity does not compromise user privacy. If permission is granted, the method 530 may proceed to determine whether the context indicates combining the image associated with the first user profile with the first media output. This decision may be based on the context previously determined by the machine learning model. If the combination is deemed appropriate based on the context, a second context associated with combining the image is determined using the machine learning model. This additional context analysis may ensure that the combination is meaningful and enhances the collaborative output. A third media output may be generated based on this second context. This iterative process of context determination and media generation may allow for sophisticated and nuanced collaborative creations. The iterative nature of the method 530, allowing for multiple rounds of input and context-based generation, suggests a dynamic and engaging user experience. Users can see their inputs reflected in evolving media outputs, potentially encouraging further interaction and creativity.

Method 530 may be flexible in terms of output formats. The second media output and the third media output may include still image, 3D media, video, or audio, allowing for a wide range of creative possibilities. This flexibility caters to diverse user preferences and creative intentions within the messaging thread. There are potential applications in virtual or augmented reality environments, opening up avenues for immersive collaborative experiences.

Method 530 is applicable to subject matter disclosed throughout and may scale to larger groups, enabling complex collaborative projects with multiple contributors. This scalability may make the method 530 particularly useful for large team collaborations or crowd-sourced creative projects.

The disclosed subject matter offers several distinct technical effects. First, the disclosed subject matter allows for the integration of image generation capabilities within messaging platforms. This may enable users (e.g., user device 102 or user device 103) to create and share custom media content while maintaining their conversations, without switching to separate applications. The system may analyze ongoing conversation context, allowing it to interpret image generation intents based on previous exchanges. This contextual understanding may simplify interactions by allowing users to express their ideas naturally, without learning specific commands or following strict syntax.

The disclosed subject matter may also facilitate collaborative image creation. Multiple participants in a conversation may contribute to and refine the media output, fostering creativity and enhancing group communication. Near real-time iterative feedback may allow users to modify and improve generated images through natural language inputs, which may enable efficient exploration of media concepts.

The disclosed subject matter may enhance the usability and creative potential of messaging applications, providing a more intuitive and collaborative experience. The usefulness of contextual image generation may extend beyond casual communication, providing value for professional and educational applications. In educational settings, instructors and students may generate illustrative media during discussions, aiding the understanding of complex topics. This functionality enhances learning experiences by incorporating media aids directly into ongoing conversations. In professional environments, it may be used for collaborative brainstorming or remote team-building activities.

Design professionals may use the disclosed subject matter for quick prototyping and iteration of media concepts within the communication platform. This process may remove the need to switch between different tools, allowing more efficient development and refinement of ideas. Marketing teams may also use the system to collaboratively generate and visualize campaign strategies while remaining in the messaging platform, encouraging creativity and speeding up the ideation process.

In customer support scenarios, representatives may use the system to create custom explanatory media tailored to specific client inquiries. This capability improves the clarity of technical support and product-related guidance, enhancing customer experience and reducing resolution time. The disclosed subject matter may function as a versatile tool that expands its utility across various professional and educational fields, improving efficiency and creativity in visual communication. Methods, systems, and apparatuses disclosed herein provides approaches for collaborative media creation in messaging environments, which may leverage machine learning for context understanding. The flexibility in input and output formats, combined with the potential for immersive display options, may provide a tool for creative collaboration.

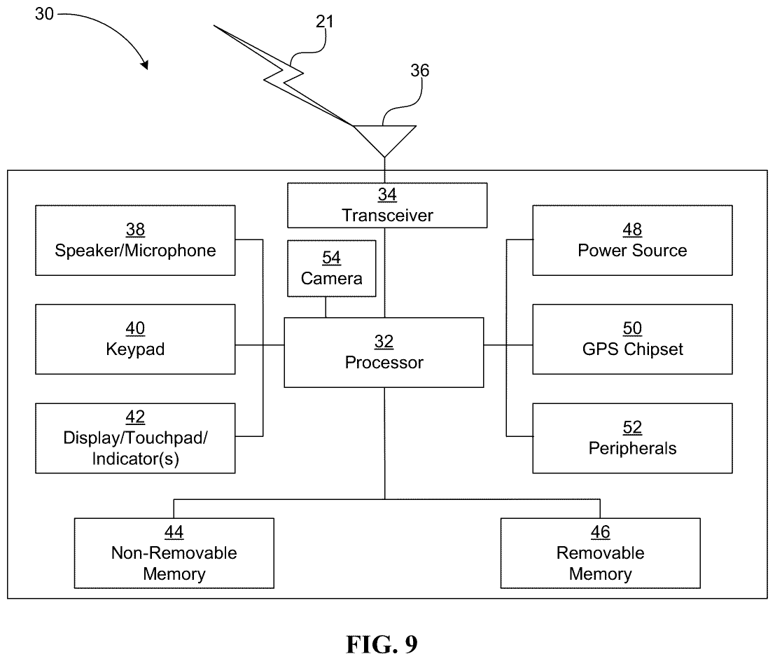

FIG. 9 illustrates an example block diagram of an electronic device in accordance with an example illustrates a block diagram of an example hardware/software architecture of user equipment (UE) 30. As shown in FIG. 9, the UE 30 (also referred to herein as node 30 and communication device 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals 21 to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

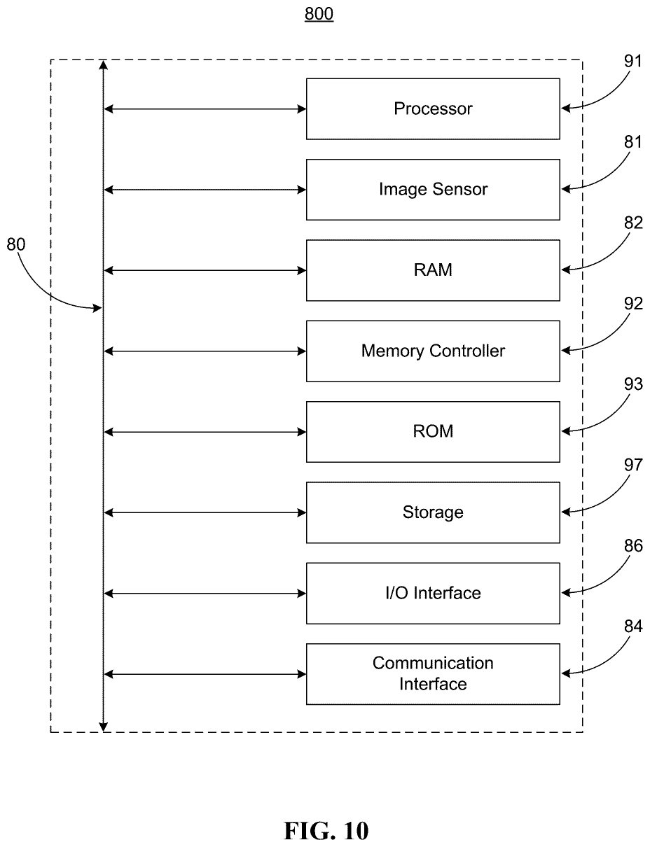

FIG. 10 illustrates an example schematic of an example processing system 800 that may implement components of the system or be part of the UE 30 of FIG. 9. The processing system 800 may also be referred to herein as computing system 800. The processing system 800 is one example of a suitable processing system 800 within a device (e.g., mobile phone, laptop, tablet, or any device with messaging capabilities) and is not intended to suggest any limitation as to the scope of use or functionality of examples of the methodology described herein. The processing system 800 may comprise a computer, network device, or server and may be controlled primarily by computer readable instructions, which may be in the form of software, wherever, or by whatever means such software is stored or accessed. Such computer readable instructions may be executed within a processor, e.g., processor 91, to cause processing system 800 to operate. In operation, processor 91 fetches, decodes, and executes instructions, and transfers information to and from other resources via the processing systems 800 main data-transfer path, bus 80. Bus 80 connects the components in processing system 800 and defines the medium for data exchange. Bus 80 typically includes data lines for sending data, address lines for sending addresses, and control lines for sending interrupts and for operating the bus 80.

In particular examples, bus 80 includes hardware, software, or both coupling components of processing system 800 to each other. As an example and not by way of limitation, bus 80 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 80 may include one or more buses, where appropriate. Although this disclosure describes and illustrates a particular bus, this disclosure contemplates any suitable bus or interconnection.

Memories coupled to bus 80 include RAM 82 and ROM 93. Such memories may include circuitry that allows information to be stored and retrieved. ROMs 93 generally contain stored data that cannot easily be modified. Data stored in RAM 82 may be read or changed by processor 91 or other hardware devices. In some examples, access to RAM 82 and/or ROM 93 may be controlled by memory controller. A memory controller may provide an address translation function that translates virtual addresses into physical addresses as instructions are executed. Memory controllers may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In some examples, I/O interface 86 includes hardware, software, or both, providing one or more interfaces for communication between processing system 800 and one or more I/O devices. Processing system 800 may include one or more of these I/O devices, where appropriate. One or more of these I/O devices may enable communication between a person and processing system 800. As an example, and not by way of limitation, a I/O device may include a keyboard, keypad, microphone, monitor, mouse, printer, scanner, speaker, still camera, stylus, tablet, touch screen, video camera, another suitable I/O device, or a combination of two or more of these. An I/O device may include one or more sensors. This disclosure contemplates any suitable I/O devices and any suitable I/O interfaces for them. Where appropriate, I/O interface 86 may include one or more device or software drivers enabling processor 91 to drive one or more of these I/O devices. I/O interface 86 may include one or more I/O interfaces, where appropriate. Although this disclosure describes and illustrates a particular I/O interface, this disclosure contemplates any suitable I/O interface.

In some examples, storage 97 includes mass storage for data or instructions. As an example, and not by way of limitation, storage 97 may include a hard disk drive (HDD), flash memory, random access memory (RAM), read only memory (ROM), non-volatile read only memory (NVROM) or a Universal Serial Bus (USB) drive or a combination of two or more of these. Storage 97 may include removable or non-removable (or fixed) media, where appropriate. Storage 97 may be internal or external to processing system 800, where appropriate. In some examples, storage 97 is non-volatile, solid-state memory. In particular examples, storage 97 includes read-only memory (ROM). This disclosure contemplates mass storage taking any suitable physical form. Storage 97 may include one or more storage control units facilitating communication between processor 91 and storage 97, where appropriate. Where appropriate, storage 97 may include one or more storages 97. Although this disclosure describes and illustrates particular storage, this disclosure contemplates any suitable storage.

In some examples, communication interface 84 includes hardware, software, or both providing one or more interfaces for communication (such as, for example, packet-based communication) between processing system 800 and one or more other processing systems 800 or one or more networks. As an example, and not by way of limitation, communication interface 84 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface for it. As an example, and not by way of limitation, processing system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, processing system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Processing system 800 may include any suitable communication interface 84 for any of these networks, where appropriate. Communication interface 84 may include one or more communication interfaces 84, where appropriate. Although this disclosure describes and illustrates a particular communication interface, this disclosure contemplates any suitable communication interface.

The components of processing system 800 may include processor 91, RAM 82, ROM 93, memory controller 92, storage 97, input/output (I/O) interface 86, communication interface 84, and bus 80. Although the present disclosure describes and illustrates a particular processing system having a particular number of particular components in a particular arrangement, this disclosure contemplates any suitable processing system having any suitable number of any suitable components in any suitable arrangement.

In some examples, ROM 93 includes main memory for storing instructions for processor 91 to execute or data for processor 91 to operate on. Whereas RAM 82 may include temporary memory for possible transfer to main memory (e.g., ROM 93) when determined by the processor 91. As an example, and not by way of limitation, processing system 800 may load instructions from storage 97 or another source (such as, for example, another processing system 800) to ROM 93. Processor 91 may then load the instructions from ROM 93 to an internal register or internal cache. To execute the instructions, processor 91 may retrieve the instructions from the internal register or internal cache and decode them. During or after execution of the instructions, processor 91 may write one or more results (which may be intermediate or final results) to the internal register or internal cache. Processor 91 may then write one or more of those results to ROM 93 or RAM 82. In particular examples, processor 91 executes only instructions in one or more internal registers or internal caches or in ROM 93 or RAM 82 (as opposed to storage 97 or elsewhere) and operates only on data in one or more internal registers or internal caches or in ROM 93 or RAM 82 (as opposed to storage 97 or elsewhere).

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In some examples, the processing system 800 may incorporate image capture for purposes of visual localization, or real time display of imagery captured of the local environment to support augmented reality functionality. In such examples, the processing system 800 may further include, for example, one or more image sensor 81. Plurality of image sensors 81 may be coupled, via bus 80, with processor 91, and operates to manage transfer of control signaling data between a processor 91 and the imaging sensor 81.

FIG. 11 illustrates an example framework 1000 that may be employed by system 100 associated with machine learning. The framework 1000 may be hosted remotely. Alternatively, the framework 1000 may reside within the intelligent messaging platform 115 as shown in FIG. 1 or be processed by a device (e.g., computing system 800, UE 30, user device 102, user device 103). The machine learning model 1010 may be operably coupled with the stored training data 1020 in a database (e.g., data store 122). In some examples, the machine learning model 1010 may be associated with other operations. The machine learning model 1010 may implement one or more machine learning model(s) or another device.

In another example, the training data 1020 may include attributes of thousands of objects. For example, the objects may be smart phones, persons, books, newspapers, news articles, signs, cars, audio, images, movies, TV shows, other videos, other items, and the like. Attributes may include but are not limited to a size, shape, orientation, and position of an object, etc. The training data 1020 employed by the machine learning model 1010 may be fixed or updated periodically (e.g., by computing system 800, communication device 30). Alternatively, the training data 1020 may be updated in real-time based upon the evaluations performed by the machine learning model 1010 in a non-training mode. This is illustrated by the double-sided arrow connecting the machine learning model 1010 and stored training data 1020.

In operation, the machine learning model 1010 may evaluate attributes of media, e.g., text, images, videos, audio, or the like obtained by hardware (e.g., user device 102, user device 103). For example, the attributes of the extracted media (e.g., features from an image(s), video(s), reel(s), post(s), story, and/or text, etc.) may be compared with respective attributes of stored training data 1020 (e.g., prestored objects).

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples. It is contemplated that methods may apply to the user or to the group.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

Some portions of this description describe the examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as models, without loss of generality. The described operations and their associated models may be embodied in software, firmware, hardware, or any combinations thereof.

Any of the steps, operations, or processes described herein may be performed or implemented with one or more hardware or software modules, alone or in combination with other devices. In one example, a software module is implemented with a computer program product comprising a computer-readable medium containing computer program code, which can be executed by a computer processor for performing any or all of the steps, operations, or processes described.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Examples also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples also may relate to a product that is produced by a computing process described herein. Such a product may comprise information resulting from a computing process, where the information is stored on a non-transitory, tangible computer readable storage medium and may include any example of a computer program product or other data combination described herein.

In particular embodiments, the deletion of any user data may be subject to data retention policies, which may limit the duration such user data that may be user or stored by the system 100, other entities (e.g., other users or third-party systems), or particular processes (e.g., internal research, advertising algorithms, machine-learning algorithms) for a particular purpose before being automatically deleted, de-identified, or otherwise made inaccessible. The data retention policies may ensure that user data may be accessed by such entities or processes only for the duration it is relevant and necessary for such entities or processes for the particular purpose. In particular embodiments, privacy settings may allow users to review any of their user data stored by the system 100 or other entities for any purpose and delete such user data when requested by the user.

In particular embodiments, privacy policies may limit the types of user data that may be collected, used, or shared by particular processes of system 100 or other processes (e.g., internal research, advertising algorithms, machine-learning algorithms) for a particular purpose. The system 100 may present users with an interface indicating the particular purpose for which user data is being collected, used, or shared. The privacy policies may ensure that only necessary and relevant user data is being collected, used, or shared for the particular purpose, and may prevent such user data from being collected, used, or shared for unauthorized purposes.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

In an example, a method of AI creating (e.g., generating) media may include receiving a first input, via a first user device associated with a first user, associated with a first media item shared, posted, or added to a platform. A first media input, associated with a first user, may be received. The first media item may be adjusted based on the first media input, wherein a machine learning model may be utilized to determine a manner in which the first media may be adjusted to create a first adjusted media. The adjusted first media item may be created and provided via a graphical user interface of one or more devices (e.g., head-mounted devices (HMDs), smartphones, tablets, smartwatches, computing devices, other communication devices, or the like) associated with one or more users. The method may further include receiving a second input, via a second user device associated with a second user, associated with the adjusted first media item shared, posted, or added to a platform. Second media input associated with a second user may be received. The first media item may be adjusted based on the second media input, wherein a machine learning model may be utilized to determine a manner in which the first media may be adjusted to create a second adjusted media item. The second adjusted media item may be created and provided via a graphical user interface of one or more devices (e.g., HMDs, smartphones, tablets, smartwatches, computing devices, other communication devices, or the like) associated with a one or more users. The machine learning model may enable the one or more users to further adjust or change a plurality of media items based on one or more media inputs by a user(s). All combinations (including the removal or addition of features) in this paragraph and the above paragraphs are contemplated in a manner that is consistent with the other portions of the detailed description.

The machine learning model may create adjusted media associated with received media input. The machine learning model may utilize a neural network to generate an association between one or more media inputs, previous media edits/modifications associated with one or more users, a contextual baseline of a conversation (e.g., a group of users chatting) or media. The machine learning model may provide adjusted/modified media. The adjusted media may reflect the media input provided by a user(s). In some examples, the machine learning model may be trained based on statistical models to analyze vast amounts of data, learning patterns and connections between words, phrases, natural language patterns, and/or previously selected replies associated with a user(s). In various examples, the machine learning model may utilize one or more neural networks to develop associations between received media input(s) and media, natural language patterns, previously adjusted media, and/or context of a conversation. The machine learning model may facilitate providing adjusted media to a user(s) via a graphical user interface of a device (e.g., HMDs, smartphones, tablets, smartwatches, computing devices, other communication device, or the like). In some examples, the machine learning model may further adjust or change the media based on one or more received media inputs Methods, systems, or apparatus with regard to media creation and adjustment using machine learning models are disclosed herein.

A method, system, computer program product, or apparatus may provide for receiving media input via a device associated with a user; applying a machine learning model to analyze context of the media input; creating, via the machine learning model, a media item associated with the context of the media input; and presenting the media item (e.g., media output) via a graphical interface of the device. In some implementations, the method may include receiving a first media input and media input; determining a region of interest in the first media associated with the media input; adjusting the region of interest corresponding to the context of the media input; creating a second media based on the adjusted region of interest; and presenting the second media. The method may further involve receiving an indication of a reply associated with a media edit from a second user, where the indication corresponds to a pressure level associated with the first media; creating an adjusted media based on the region of interest and media input; and presenting the adjusted media on multiple devices. In some scenarios, the method may involve multiple rounds of adjustments based on inputs from different users (e.g., in a group chat), creating multiple adjusted media items. The apparatus may comprise at least one processor and a memory coupled with the processor, with the memory including computer executable instructions to perform the described methods. All combinations (including the removal or addition of features) in this paragraph and the above paragraphs are contemplated in a manner that is consistent with the other portions of the detailed description.

In one aspect, a method is provided that includes: receiving, at a messaging platform, a first message from a first user, the first message comprising a media item; receiving a second message from a second user, the second message comprising a text instruction for modifying the media item; processing the text instruction using a natural language processing model to determine modifications to apply to the media item; applying the determined modifications to the media item using one or more machine learning models to generate a modified media item; and sending the modified media item to one or more users in a messaging thread. Collaboration features may enable multiple users to jointly create or modify media in a shared thread. In some examples, the media item comprises an image, video, or audio clip. The modifications may include adding or removing content, replacing content, changing a background, adjusting a visual style, extending a narrative, changing a media format, or adjusting a composition.

Methods, systems, or apparatus with regard to collaborative media creation in messaging threads using machine learning models are disclosed herein. A method, system, or apparatus may provide for receiving a first media input in a messaging thread, wherein the messaging thread comprises participants associated with multiple user profiles, including a first user profile and a second user profile, and wherein the first media input is associated with a change of a first portion of a first media output and is associated with the first user profile; receiving a second media input associated with a change of a second portion of the first media output, the second message associated with the second user profile; determining context associated with the first media input and the second media input using a machine learning model; and generating a second media output based on the context, wherein the second media output comprises an animation associated with the first media output. This method may allow for collaborative media creation and modification within a messaging environment, leveraging machine learning to understand context and generate animated outputs based on multiple users' inputs. The change of the first portion of the first media input may include adding audio to the first media output. The first user profile and the second user profile may be different. The animation may be based on the first media input and the second media input. All combinations (including the removal or addition of features) in this paragraph and above paragraphs are contemplated in a manner that is consistent with the other portions of the detailed description.

Methods, systems, or apparatus with regard to collaborative media creation in messaging threads are disclosed herein. The method may involve determining that there is an indication of permission to combine an image associated with the first user profile with the first media output; based on the indication of permission to combine, determining that the context indicates combining the image associated with the first user profile with the first media output; determining a second context associated with the combining the image associated with the first user profile with the first media output using the machine learning model; and generating a third media output based on the context. This method may allow for collaborative media creation and modification within a messaging environment, leveraging machine learning to understand context, respect user permissions, and generate multiple iterations of media outputs based on user inputs and profile-associated images. All combinations (including the removal or addition of features) in this paragraph and the above paragraphs are contemplated in a manner that is consistent with the other portions of the detailed description.

What is claimed:

1. A method comprising:
receiving a first media input in a messaging thread,
wherein the messaging thread comprises participants associated with multiple user profiles, wherein the multiple user profiles comprise a first user profile and a second user profile, wherein the first media input is associated with a change of a first portion of a first media output, wherein the first media input is associated with the first user profile;
receiving a second media input in the messaging thread, the second media input associated with a change of a second portion of the first media output, the second media input associated with the second user profile;
determining context associated with the first media input and the second media input using a machine learning model; and
generating a second media output based on the context.

2. The method of claim 1, wherein the second media output comprises an animation associated with the first media output.

3. The method of claim 1, wherein the change of the first portion of the first media output comprises adding audio to the first media output.

4. The method of claim 1, wherein the first media input comprises text.

5. The method of claim 1, further comprising:
determining that there is an indication of permission to combine an image associated with the first user profile with the first media output;
determining, based on the indication of the permission to combine, that the context indicates combining the image associated with the first user profile with the first media output;
determining a second context associated with the combining the image associated with the first user profile with the first media output using the machine learning model; and
generating a third media output based on the second context.

6. The method of claim 1, wherein the second media output comprises an image, a video, or audio.

7. The method of claim 1, wherein the second media output is displayed by a head-mounted display.

8. A device comprising:
one or more processors; and
at least one memory storing instructions, that when executed by the one or more processors, cause the device to:
receive a first media input in a messaging thread,
wherein the messaging thread comprises participants associated with multiple user profiles, wherein the multiple user profiles comprise a first user profile and a second user profile, wherein the first media input is associated with a change of a first portion of a first media output, wherein the first media input is associated with the first user profile;
receive a second media input in the messaging thread, the second media input associated with a change of a second portion of the first media output, the second media input associated with the second user profile;
determine context associated with the first media input and the second media input using a machine learning model; and
generate a second media output based on the context.

9. The device of claim 8, wherein the second media output comprises an animation associated with the first media output.

10. The device of claim 8, wherein the change of the first portion of the first media output comprises adding audio to the first media output.

11. The device of claim 8, wherein the first media input comprises text.

12. The device of claim 8, wherein when the one or more processors execute the instructions, the device is configured to:
determine that there is an indication of permission to combine an image associated with the first user profile with the first media output;
determine, based on the indication of the permission to combine, that the context indicates combining the image associated with the first user profile with the first media output; and
determine a second context associated with the combining the image associated with the first user profile with the first media output using the machine learning model; and
generate a third media output based on the second context.

13. The device of claim 8, wherein the second media output comprises an image, a video, or audio.

14. The device of claim 8, wherein the second media output is displayed in a head-mounted display.

15. A non-transitory computer-readable medium storing instructions, that when executed, cause:
receiving a first media input in a messaging thread,
wherein the messaging thread comprises participants associated with multiple user profiles, wherein the multiple user profiles comprise a first user profile and a second user profile, wherein the first media input is associated with a change of a first portion of a first media output, wherein the first media input is associated with the first user profile;
receiving a second media input in the messaging thread, the second media input associated with a change of a second portion of the first media output, the second media input associated with the second user profile;
determining context associated with the first media input and the second media input using a machine learning model; and
generating a second media output based on the context.

16. The non-transitory computer-readable medium of claim 15, wherein the second media output comprises an animation associated with the first media output.

17. The non-transitory computer-readable medium of claim 15, wherein the change of the first portion of the first media output comprises adding audio to the first media output.

18. The non-transitory computer-readable medium of claim 15, wherein the first media input comprises text.

19. The non-transitory computer-readable medium of claim 15, wherein the instructions, when executed, further cause:
determining that there is an indication of permission to combine an image associated with the first user profile with the first media output;
determining, based on the indication of the permission to combine, that the context indicates combining the image associated with the first user profile with the first media output;
determining a second context associated with the combining the image associated with the first user profile with the first media output using the machine learning model; and
generating a third media output based on the second context.

20. The non-transitory computer-readable medium of claim 15, wherein the second media output is displayed in artificial reality by a head-mounted display.
